(19) United States
(12) Patent Application Publication
(10) Pub. No.: US 2025/0290248 A1
(43) Pub. Date: Sep. 18, 2025

(54) ELASTOMERIC-RESIN HYBRID COMPOSITE WITH ELASTOMERIC LAYERS

(71) Applicant: Wolverine Advanced Materials, LLC, Dearborn, MI (US)

(72) Inventors: Abed Hasheminasab, Farmington Hills, MI (US); Devon Urbina, Berkley, MI (US); Kush Gulati, Farmington Hills, MI (US); Zaria Alexander, Wayne, MI (US); Bryan Grace, Dearborn, MI (US); Yongpan Ma, Northville, MI (US)

(73) Assignee: Wolverine Advanced Materials, LLC, Dearborn, MI (US)

(21) Appl. No.: 19/076,544

(22) Filed: Mar. 11, 2025

Related U.S. Application Data
(60) Provisional application No. 63/564,203, filed on Mar. 12, 2024.

(51) Int. Cl. D06M 15/55; B05D 1/18; D06M 10/10; D06M 11/00; D06M 15/693; D06M 17/04; D06M 23/10

(52) U.S. Cl. CPC D06M 15/55; B05D 1/18; D06M 10/10; D06M 11/00; D06M 15/693; D06M 17/04; D06M 23/10; B05D 2203/35; B05D 2210/00; B05D 2256/00; B05D 2401/10; B05D 2430/00; B05D 2504/00; B05D 2601/20; C08J 2309/02; C08J 2363/00; D10B 2101/06

(57) ABSTRACT

A noise, vibration, harshness (NVH) mitigation material comprising a non-metallic woven fabric substrate impregnated with a resin and one or more elastomeric layers applied to at least one surface of the non-metallic woven fabric substrate is disclosed herein. A method to fabricate a noise, vibration, harshness (NVH) mitigation material comprising preparing an impregnating resin comprising a resin and one or more of a filler and a toughening agent; impregnating a non-metallic woven fabric substrate with the impregnating resin by soaking the non-metallic woven fabric substrate with the impregnating resin, drying the impregnated non- metallic woven fabric substrate, and curing the impregnated non-metallic woven fabric substrate; and applying one or more elastomeric coatings onto the impregnated non-metallic woven fabric substrate is also disclosed herein.

### CROSS-REFERENCE TO RELATED APPLICATION

This application claims priority to U.S. provisional application No. 63/564,203, filed Mar. 12, 2024, the entire contents of which are incorporated herein by reference.

### FIELD OF DISCLOSURE

The present disclosure relates to noise, vibration, harshness (NVH) mitigation materials and methods of fabricating such materials.

### BACKGROUND

Unless otherwise indicated herein, the materials described in this section are not prior art to the claims in this application and are not admitted as prior art by inclusion in this section.

High performance elastomeric composites are utilized in a variety of industries including, but not limited to, automotive industry (brake systems (NVH performance); gaskets (sealing performance) for exhaust, engine, transmission, etc.; cabin comfort (sound deadening) covering roof, floor, and door panels; EV vehicles covering e-compressor, thermal management system, e-motor, and invertor), aerospace industry such as sound insulation in aircraft cabins, and construction industry covering sound insulation in floors, roofs, and walls.

### SUMMARY

The present disclosure generally describes various elastomeric coated flexible woven non-metallic substrates for sealing and noise reduction applications.

In some examples, a non-metallic substrate coated with elastomeric layer(s) may include a woven fiber material that is reinforced with resin impregnation. The resin may be a resin-elastomeric hybrid. The resin may also contain fillers to enhance structural and mechanical properties (e.g., sound and/or thermal insulation). The fiber reinforced resin composite may be formed as a pre-impregnated coil. The fiber reinforced resin composite may also have a primer and have a viscoelastic coating applied. The viscoelastic coatings and primers may be applied in a continuous or semi-continuous coil coating process. The viscoelastic coatings may be applied in a liquid state. The viscoelastic coatings may be foamed or non-foamed. The fiber reinforced resin composite with viscoelastic layers may be cured simultaneously and may have acoustic damping adhesive layers applied. The acoustic damping adhesive layers may be applied via liquid coating or lamination.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A illustrates a process of fabricating elastomeric-resin hybrid composites with elastomeric layers;

FIG. 1B illustrates fiberglass cores at different phases of the fabrication process;

FIG. 1C illustrates layers of an elastomeric-resin hybrid composite with elastomeric layer;

FIG. 1D illustrates a fabricated elastomeric-resin hybrid composite with an elastomeric layer;

FIG. 2A illustrates reaction time vs. heat flow graphs of an example epoxy impregnating resin at different temperatures;

FIG. 2B illustrates conversion rate vs. temperature graphs of an example epoxy impregnating resin at different temperatures; and

FIG. 2C illustrates thermogravimetric analysis (TGA) results for a number of elastomeric-resin hybrid formulations;

arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to compounds, methods, apparatus, systems and/or devices related to providing various elastomeric coated non-metallic substrates for sealing and noise reduction applications. For example, elastomeric-resin hybrid composites with elastomeric layers, which may include acoustic damping adhesive layers.

According to some examples, an elastomeric material, which is covalently bonded to a flexible woven fabric core may be used in a variety of noise and vibration reduction and/or sealing applications with additional benefits such as improved corrosion resistance. The woven fabric core, once impregnated, provides stiffness, but at the same time flexibility to conform to complex shapes. The elastomeric coated flexible non-metallic core may be implemented in a variety of fields, where noise, vibration, and harshness (NVH) and/or sealing is needed.

As mentioned herein, an elastomeric coated flexible non-metallic core (elastomeric-resin hybrid composite) may be implemented in a variety of fields, where noise, vibration, and harshness (NVH) and/or sealing is needed. EV or conventional automotive applications may include motor noise mitigation/vibration, brake noise/vibration, and cabin noise/vibration mitigations. The elastomeric-resin hybrid composite may be applied to various interfaces, and structural parts (roof, doors, floor, service panels, etc.).

In aerospace applications, inside surfaces of an aircraft cabin may be covered with an elastomeric-resin hybrid composite to dampen noise/vibration. In construction applications, various parts of a building such as floors, walls, ceilings, roof, etc. may be treated with sound/vibration dampening material based on the elastomeric-resin hybrid composite. Other example implementation environments may include, but are not limited to, ships, trains, specialty structures, and comparable ones.

Thus, a flexible woven non-metallic impregnated elastomeric composite may be used in automotive, aerospace, construction, and other industries to provide NVH and/or sealing properties. The woven fabric core may be fiberglass, carbon fiber, cellulose, polyester, nylon, or similar materials consisting of various weave patterns. The weave patterns can consist of plain, 2 by 2, 4 by 4, 4 harness satin, 8 harness stain, or basket type weave. The weave pattern is characterized by how the filling yarn intertwines with the warp yarn. Different weaves can introduce unique properties such as flexibility (i.e. conforming to complex shapes), strength, and amount of resin absorption. The woven fiber core, once impregnated, acts as a support for the elastomeric coating providing stiffness as well as flexibility. In some examples, the woven fiber core may be modified in such a way to achieve unique properties tailored to the applications mentioned herein. For example, fillers such as manganese black ferrite spinel, aluminum oxide, zirconia, silica dioxide, titanium dioxide, carbides, nano ceramics, and similar ones may be used which can provide reinforcement to increase the overall strength of the final composite as well as increase density and stiffness to improve the overall NVH properties. Since fiber glass is inherently weak, specific high-performance resins are required in order to achieve the desired properties. Resins may include, but are not limited to, epoxy, polyamideimide, urethane, carboxylated rubber, polysulfone, polyether sulfone, and polyetherimide. Toughening agents may include, but are not limited to, carboxylated acrylonitrile butadiene rubber, polysulfone, polyether sulfone, polyester, and polyphenylene ether. Toughening agents are necessary to impart flexibility into the final composite. Toughening agents are compatible with the resin system creating a hybrid elastomeric-resin coating which introduces flexible domains within the matrix improving flexibility as well as stress dissipation.

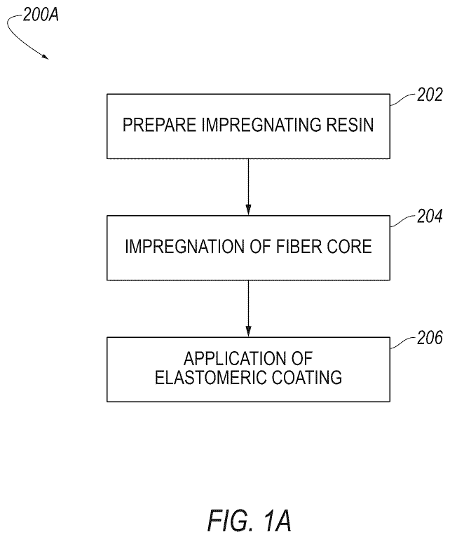

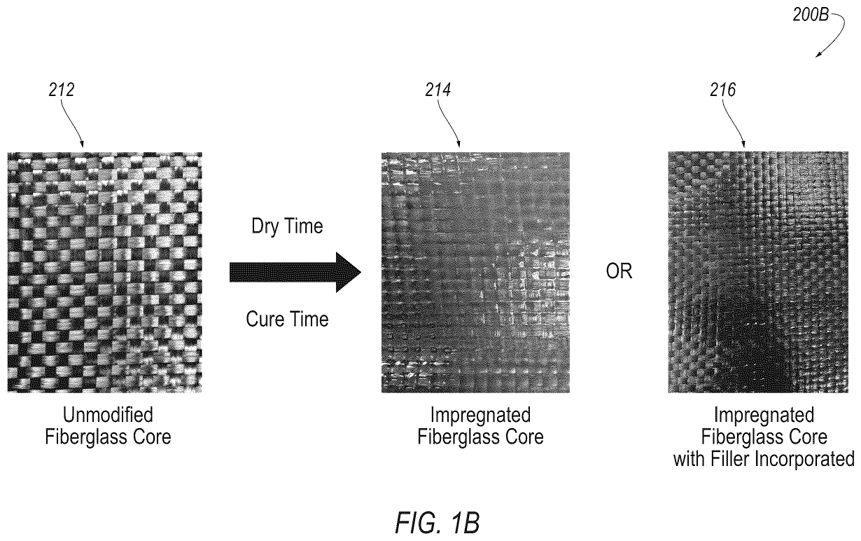

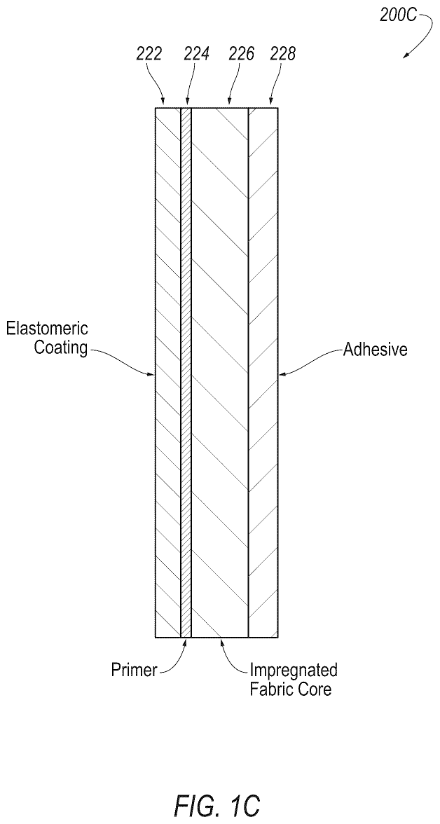

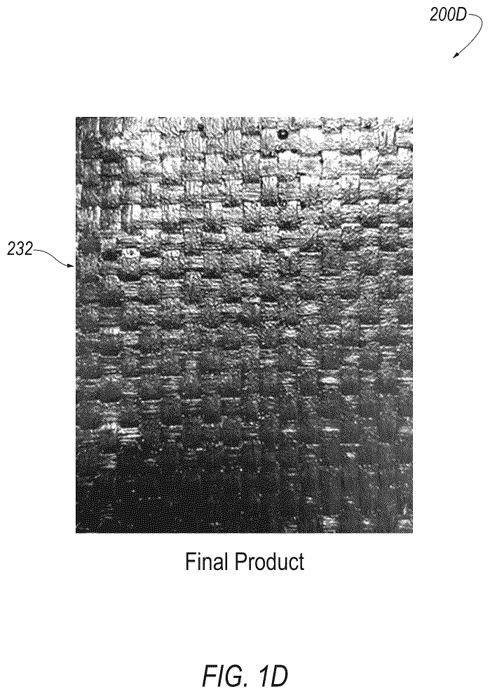

FIG. 1A illustrates a process of fabricating elastomeric-resin hybrid composites with elastomeric layers, arranged in accordance with at least some embodiments described herein.

According to some examples, an elastomeric material may be covalently bonded to a flexible woven fabric core. The woven fabric core, which may be reinforced with resin impregnation, provides stiffness, but at the same time flexibility to conform to complex shapes for a variety of application environments. As shown in diagram 200A, a first step in fabrication of the elastomeric-resin hybrid composite with elastomeric layer may be preparation of impregnating resin 202. Because the fabric core is inherently weak (i.e., low mechanical properties), the fabric may be modified in such a way to improve tensile strength, stiffness, and to increase its overall density. The incorporation of an impregnating resin and/or fillers may be used for an end application.

The impregnating resin may include, but is not limited to, a resin such as an epoxy, phenol-formaldehyde, urea-formaldehyde, melamine-formaldehyde, polyester-imide, polyimide, and comparable materials. Optionally, a filler may be used to provide additional improvement of mechanical properties. The filler may include, but is not limited to, metal oxides, aluminum oxide, zirconia, silica dioxide, titanium dioxide, manganese black ferrite spinel, metal carbides, zirconia carbide, tungsten carbide, cementite, nano-ceramics, and similar materials. Additionally and optionally, a toughening agent may also be used. The toughening agent may include carboxylate acrylonitrile butadiene rubber, polysulfone, polyether sulfone, polyester, and/or polyphenylene ether.

The second step in the fabrication process may be impregnation of the fiber core 204. A variety of woven fabrics may be utilized as the non-metallic core. The fabrics may have different weave patterns as well fiber thicknesses, which can influence the final mechanical properties. Typical weave patterns include but are not limited to plain, 2 by 2, 4 by 4, 4 harness satin, 8 harness stain, or basket type weave with an overall thickness ranging from 0.006 in to 0.030 in. The fiber core may include, but is not limited to, fiberglass, carbon fiber, cellulose, nylon, polyamide-imide, polyimide, and similar materials. Through the use of non-metal fiber core, the described materials may provide the additional benefit of rust-resistance.

The impregnation process may encompass soaking the fiber core in the impregnating resin, removing the fiber core and removing excess resin solution, drying the impregnated core (e.g., for 1-24 hrs), curing the impregnated core (e.g., for 5-30 minutes at 100° C. to 190° C.). The impregnated core may be only partially cured at this step allowing for any unreacted functional moieties to react with the primer/elastomeric coating applied next at the third step.

The third step in the fabrication process may be application of elastomeric coating 206. A variety of elastomeric coatings may be applied to the impregnated fabric core. The coating may be applied as a liquid (i.e., dissolved in a solvent) or as a thin film (i.e., calendered). The final elastomeric coating may be foamed or non-foamed. A primer layer may be used to promote adhesion of the elastomeric coating to the woven impregnated fabric. Example elastomers for coating may include, but are not limited to, acrylonitrile butadiene rubber (NBR), hydronated butadiene rubber (HNBR), fluorinated rubber (FKM), acrylic rubber (ACM and AEM), ethylene propylene diene (EPDM), silicone (vMQ or PVMQ), fluorinated silicone (FVMQ), polyurethanes (PU or PUR), and similar materials.

FIG. 1B illustrates fiberglass cores at different phases of the fabrication process, arranged in accordance with at least some embodiments described herein. As shown in diagram 200B, an unmodified fiberglass core 212 upon being impregnated with the resin, dried and cured becomes impregnated fiberglass core 214. If a filler is used, the result is an impregnated fiberglass core with filler incorporated 216.

FIG. 1D illustrates a fabricated elastomeric-resin hybrid composite with an elastomeric layer, arranged in accordance with at least some embodiments described herein. The final product 232 (impregnated fiberglass core coated with one or more elastomeric layers) shown in diagram 200D provides the stiffness and flexibility for applications in harsh environments and a wide variety of shapes and forms for the material.

FIG. 1C illustrates layers of an elastomeric-resin hybrid composite with elastomeric layer, arranged in accordance with at least some embodiments described herein. As shown in diagram 200C, at the center of the final product is the impregnated fabric (e.g., fiberglass) core 226. One surface of the cured impregnated fabric core 226 may be coated with an adhesive layer 228. In addition to allowing the material to be adhered to a substrate surface, the adhesive layer 228 may provide additional NVH properties to prevent noise and squeal through hysteresis by transforming the unwanted vibrational energy to heat and canceling out the noise. Example adhesives may include, but are not limited to, silicone, fluorosilicone, acrylic, phenolic.

Elastomeric coating 222 may be applied to one or both surfaces of the impregnated fabric core 226. In some examples, an optional primer layer 224 may be applied to one or both surfaces of the impregnated fabric core 226 first, then the elastomeric coating 222 is applied onto the primer layer 224. The elastomeric coating may provide both sealing and/or NVH properties and may be thermally and chemically stable over a wide range of harsh environments (e.g. temperature variations, presence of gases or fluids, etc.). The elastomeric coating 222 may still maintain its flexibility, an important characteristic of sound damping materials. Vulcanization methods for the elastomeric coating 222 may include, but are not limited to, forced air, E-beam, calendering, IR curing, UV curing, etc.

While example impregnated fabric core with elastomeric coating based materials may be fabricated by a wide range of materials and techniques, some practical formulations are provided in Table 1 below as implementation examples.

TABLE 1
Example Formulations

| | | Elastomer | Filler | Methyl |
|---|---|---|---|---|
| | | (Carboxylated | (Manganese | isobutyl |
| Formulation | Resin | NBR) | Ferrite) | ketone (MIBK) |
| 1 | 100% | — | — | — |
| 2 | 40-75% | 4-6% | — | 25-50% |
| 3 | 25-35% | 9-11% | — | 55-65% |
| 4 | 70-80% | — | 20-30% | — |
| 5 | 40-53% | 4-6% | 15-18% | 25-39% |
| 6 | 21-29% | 7-9% | 10-12% | 52-60% |
| Overall | 21-100% | 0-15% | 0-40% | 0-70% |

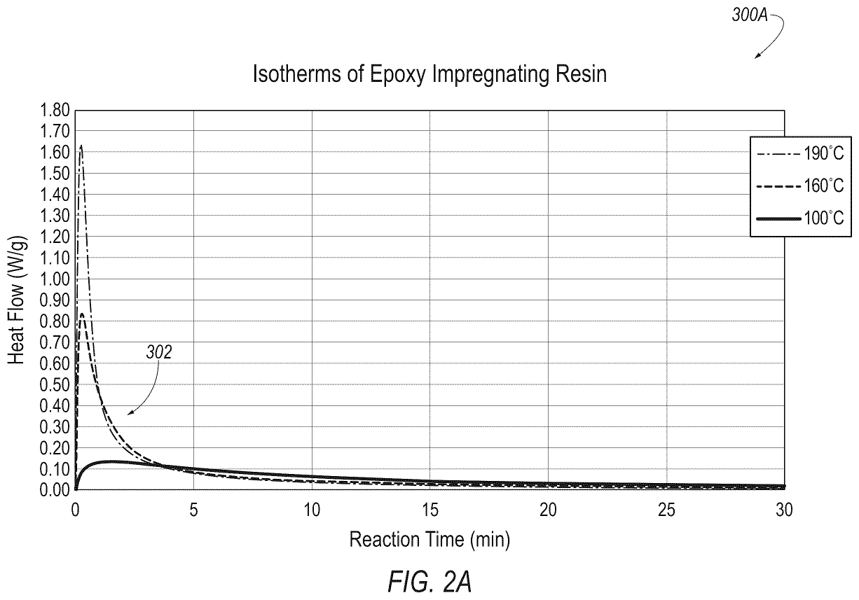

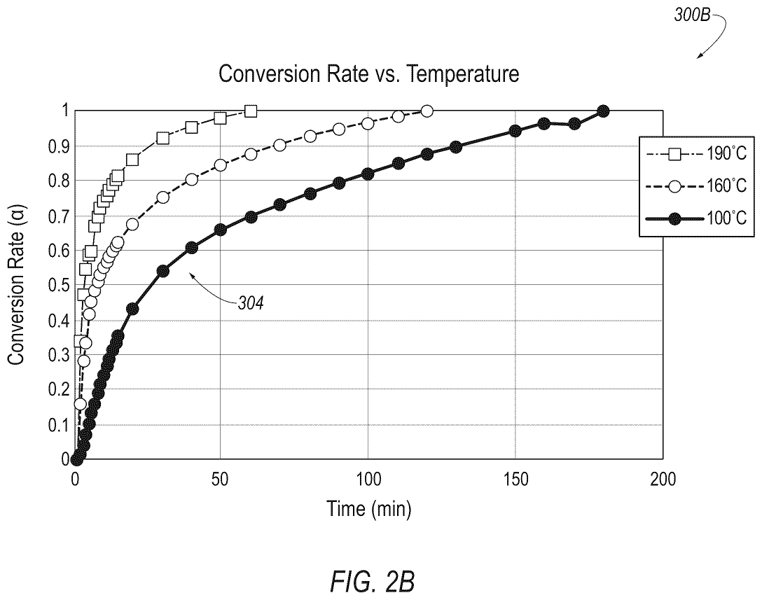

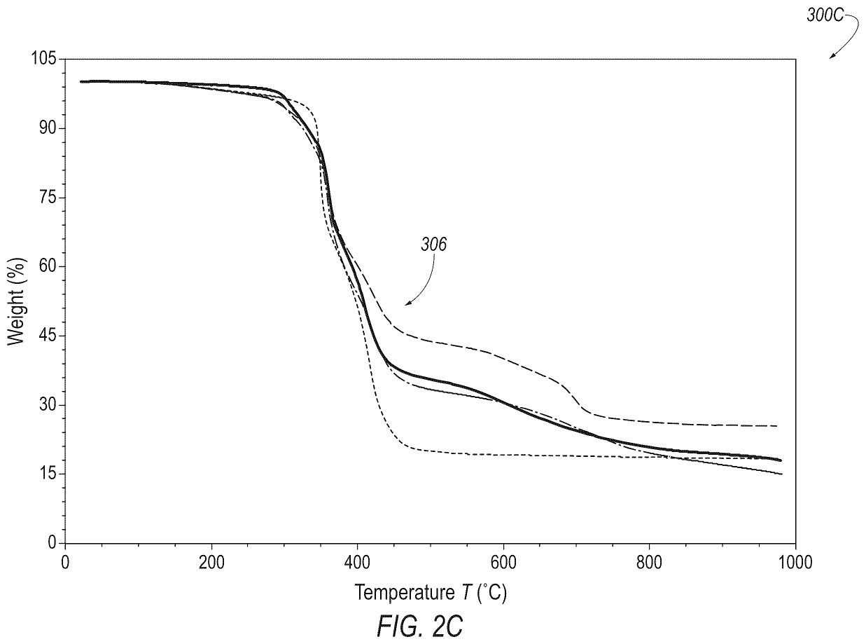

FIG. 2A illustrates reaction time vs. heat flow graphs of an example epoxy impregnating resin at different temperatures, arranged in accordance with at least some embodiments described herein. FIG. 2B illustrates conversion rate vs. temperature graphs of an example epoxy impregnating resin at different temperatures, arranged in accordance with at least some embodiments described herein.

In some examples, the cure kinetics of the impregnating resin may be tuned to adjust the mechanical properties such as tensile strength, flexibility, stiffness, etc. of the final impregnated non-metallic core. The mechanical properties may be adjusted by: (1) Adjusting ratio of functional reactive groups; (2) Addition of a toughening agent; (3) Adjusting hardener/resin ratio; and (4) Adjusting cure temperatures/cure times. Understanding the state of cure may allow for the adjustment of the overall stiffness as well as crosslink density. The resin system may be manipulated by identifying a cure state where sufficient unreacted functional sites are available allowing for the elastomeric coating to form a strong covalent bond between itself and the impregnated woven fabric.

Another important aspect is understanding how cure temperature influences the overall reaction time. This allows for process optimization as well as to tune the final properties. In some examples, the resin system may behave as an nth order type reaction where the consumption of reactants is the only factor considered. In the scope of thermokinetics, the rate of conversion depends on the rate constant (K(T)) and reaction type (F(α)). The reaction may be expressed as:

$$d α / dt = 187.72 {{e}^{- 39.2 / RT} ( 1 - α )}^{1.72} \qquad [ 1 ]$$

FIG. 2C illustrates thermogravimetric analysis (TGA) results for a number of elastomeric-resin hybrid formulations, arranged in accordance with at least some embodiments described herein.

TGA is used to determine the maximum serviceable temperature a specific formulation can withstand. The maximum serviceable temperature is usually denoted as T90. T90 is the temperature at which 90% of the formulation remains. As shown in the TGA graphs 306 in diagram 300C, four example formulations exhibit excellent thermal stability as they do not readily degrade until after 400° C. The improved thermal stability may be obtained through resin and filler choice.

The elastomer-to-substrate adhesion when subjected to methyl-ethyl ketone (MEK) or boiling water may improve with impregnated fiberglass substrate with primer as compared to unimpregnated fiberglass or impregnated fiberglass without primer. Pull-off tensile strength may also increase significantly for impregnated fiberglass substrate with primer (˜5-6 MPa) as compared to unimpregnated fiberglass (˜1-2 MPa) or impregnated fiberglass without primer (˜2 MPa).

In some examples, a non-metallic substrate coated with elastomeric layer(s) may include a woven fiber material that is reinforced with resin impregnation. The resin may be an elastomeric-resin hybrid. The resin may also contain fillers to enhance structural and mechanical properties (e.g., sound and/or thermal insulation). The fiber reinforced resin composite may be formed as a pre-impregnated coil. The fiber reinforced resin composite may also have a primer and have a viscoelastic coating applied.

The viscoelastic coatings and primers may be applied in a continuous or semi-continuous coil coating process. The viscoelastic coatings may be applied in a liquid state. The viscoelastic coatings may be foamed or non-foamed. The fiber reinforced resin composite with viscoelastic layers may be cured simultaneously and may have acoustic damping adhesive layers applied. The acoustic damping adhesive layers may be applied via liquid coating or lamination. The viscoelastic coatings may be applied with thin film lamination and cured through thermal cure, infrared cure, or electron beam cure.

The present disclosure also includes the following enumerated embodiments.

Embodiment 1. A noise, vibration, harshness (NVH) mitigation material comprising:
a non-metallic woven fabric substrate impregnated with a resin; and
one or more elastomeric layers applied to at least one surface of the non-metallic woven fabric substrate.
   Embodiment 2. The NVH mitigation material of embodiment 1, wherein the non-metallic woven fabric substrate comprises fiberglass, carbon fiber, cellulose, nylon, polyamide-imide, polyimide, or a combination thereof.
   Embodiment 3. The NVH mitigation material of embodiment 1 or 2, wherein the resin comprises an epoxy, phenol-formaldehyde, urea-formaldehyde, melamine-formaldehyde, polyester-imide, polyimide, or a combination thereof.
   Embodiment 4. The NVH mitigation material of embodiment 3, wherein the resin further includes a filler comprising metal oxide, aluminum oxide, zirconia, silica dioxide, titanium dioxide, manganese black ferrite spinel, metal carbides, zirconia carbide, tungsten carbide, cementite, nano-ceramic, or a combination thereof.
   Embodiment 5. The NVH mitigation material of embodiment 3 or 4, wherein the resin further includes a toughening agent comprising carboxylate acrylonitrile butadiene rubber, polysulfone, polyether sulfone, polyester, polyphenylene ether, or a combination thereof.
   Embodiment 6. The NVH mitigation material of any one of embodiments 1-5, wherein the one or more elastomeric layers comprise acrylonitrile butadiene rubber (NBR), hydronated butadiene rubber (HNBR), fluorinated rubber (FKM), acrylic rubber (ACM and AEM), ethylene propylene diene (EPDM), silicone (VMQ or PVMQ), fluorinated silicone (FVMQ), polyurethane (PU or PUR), or a combination thereof.
   Embodiment 7. The NVH mitigation material of any one of embodiments 1-6, wherein
a primer layer is applied to a first surface of the non-metallic woven fabric substrate impregnated with the resin,
the one or more elastomeric layers are applied onto the primer layer, and
an adhesive layer is applied to a second surface opposite the first surface of the non- metallic woven fabric substrate impregnated with the resin.
   Embodiment 8. The NVH mitigation material of embodiment 7, wherein the adhesive layer comprises silicone, fluorosilicone, acrylic, phenolic, or a combination thereof.
   Embodiment 9. The NVH mitigation material of any one of embodiments 1-8, wherein the NVH mitigation material is applied in one or more of a brake system a vehicle sound mitigation system, a construction sound mitigation system, a sealing gasket, or a combination thereof.
   Embodiment 10. A method to fabricate a noise, vibration, harshness (NVH) mitigation material, the method comprising:
preparing an impregnating resin comprising a resin and one or more of a filler and a toughening agent;
impregnating a non-metallic woven fabric substrate with the impregnating resin by:
   soaking the non-metallic woven fabric substrate with the impregnating resin;
   drying the impregnated non-metallic woven fabric substrate; and
   curing the impregnated non-metallic woven fabric substrate; and
applying one or more elastomeric coatings onto the impregnated non-metallic woven fabric substrate.
   Embodiment 11. The method of embodiment 10, wherein the non-metallic woven fabric substrate is partially cured during the impregnation and fully cured with the one or more elastomeric layers applied.
   Embodiment 12. The method of embodiment 10 or 11, further comprising:
applying a primer onto the impregnated non-metallic woven fabric substrate before the one or more elastomeric layers are applied.
   Embodiment 13. The method of any one of embodiments 10-12, wherein applying the one or more elastomeric coating or the primer comprises:
applying the one or more elastomeric coating or the primer in a continuous or semi- continuous coil coating process.
   Embodiment 14. The method of any one of embodiments 10-13, further comprising:
applying an adhesive layer onto a surface of the impregnated non-metallic woven fabric substrate opposite another surface to which the one or more elastomeric layers are applied.
   Embodiment 15. The method of any one of embodiments 10-14, wherein the non-metallic woven fabric substrate comprises fiberglass, carbon fiber, cellulose, nylon, polyamide-imide, polyimide, or a combination thereof.
   Embodiment 16. The method of any one of embodiments 10-15, wherein the resin comprises an epoxy, phenol-formaldehyde, urea-formaldehyde, melamine-formaldehyde, polyester-imide, polyimide, or a combination thereof.
   Embodiment 17. The method of embodiment 16, wherein the resin further includes a filler comprising metal oxide, aluminum oxide, zirconia, silica dioxide, titanium dioxide, manganese black ferrite spinel, metal carbides, zirconia carbide, tungsten carbide, cementite, nano-ceramic, or a combination thereof.
   Embodiment 18. The method of embodiment 16 or 17, wherein the resin further includes a toughening agent comprising carboxylate acrylonitrile butadiene rubber, polysulfone, polyether sulfone, polyester, polyphenylene ether, or a combination thereof.
   Embodiment 19. The method of any one of embodiments 10-18, wherein the one or more elastomeric layers comprise acrylonitrile butadiene rubber (NBR), hydronated butadiene rubber (HNBR), fluorinated rubber (FKM), acrylic rubber (ACM and AEM), ethylene propylene diene (EPDM), silicone (VMQ or PVMQ), fluorinated silicone (FVMQ), polyurethane (PU or PUR), or a combination thereof.
   Embodiment 20. The method of any one of embodiments 10-19, further comprising:
vulcanizing the one or more elastomeric layers through forced air, E-beam, calendering, infrared curing, or ultraviolet curing.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims. I/we claim:

1. A noise, vibration, harshness (NVH) mitigation material comprising:
a non-metallic woven fabric substrate impregnated with a resin; and
one or more elastomeric layers applied to at least one surface of the non-metallic woven fabric substrate.

2. The NVH mitigation material of claim 1, wherein the non-metallic woven fabric substrate comprises fiberglass, carbon fiber, cellulose, nylon, polyamide-imide, polyimide, or a combination thereof.

3. The NVH mitigation material of claim 1, wherein the resin comprises an epoxy, phenol-formaldehyde, urea-formaldehyde, melamine-formaldehyde, polyester-imide, polyimide, or a combination thereof.

4. The NVH mitigation material of claim 3, wherein the resin further includes a filler comprising metal oxide, aluminum oxide, zirconia, silica dioxide, titanium dioxide, manganese black ferrite spinel, metal carbides, zirconia carbide, tungsten carbide, cementite, nano-ceramic, or a combination thereof.

5. The NVH mitigation material of claim 3, wherein the resin further includes a toughening agent comprising carboxylate acrylonitrile butadiene rubber, polysulfone, polyether sulfone, polyester, polyphenylene ether, or a combination thereof.

6. The NVH mitigation material of claim 1, wherein the one or more elastomeric layers comprise acrylonitrile butadiene rubber (NBR), hydronated butadiene rubber (HNBR), fluorinated rubber (FKM), acrylic rubber (ACM and AEM), ethylene propylene diene (EPDM), silicone (VMQ or PVMQ), fluorinated silicone (FVMQ), polyurethane (PU or PUR), or a combination thereof.

7. The NVH mitigation material of claim 1, wherein
a primer layer is applied to a first surface of the non-metallic woven fabric substrate impregnated with the resin,
the one or more elastomeric layers are applied onto the primer layer, and
an adhesive layer is applied to a second surface opposite the first surface of the non- metallic woven fabric substrate impregnated with the resin.

8. The NVH mitigation material of claim 7, wherein the adhesive layer comprises silicone, fluorosilicone, acrylic, phenolic, or a combination thereof.

9. The NVH mitigation material of claim 1, wherein the NVH mitigation material is applied in one or more of a brake system a vehicle sound mitigation system, a construction sound mitigation system, a sealing gasket, or a combination thereof.

10. A method to fabricate a noise, vibration, harshness (NVH) mitigation material, the method comprising:
preparing an impregnating resin comprising a resin and one or more of a filler and a toughening agent;
impregnating a non-metallic woven fabric substrate with the impregnating resin by:
soaking the non-metallic woven fabric substrate with the impregnating resin;
drying the impregnated non-metallic woven fabric substrate; and
curing the impregnated non-metallic woven fabric substrate; and
applying one or more elastomeric coatings onto the impregnated non-metallic woven fabric substrate.

11. The method of claim 10, wherein the non-metallic woven fabric substrate is partially cured during the impregnation and fully cured with the one or more elastomeric layers applied.

12. The method of claim 10, further comprising:
applying a primer onto the impregnated non-metallic woven fabric substrate before the one or more elastomeric layers are applied.

13. The method of claim 12, wherein applying the one or more elastomeric coating or the primer comprises:
applying the one or more elastomeric coating or the primer in a continuous or semi-continuous coil coating process.

14. The method of claim 10, further comprising:
applying an adhesive layer onto a surface of the impregnated non-metallic woven fabric substrate opposite another surface to which the one or more elastomeric layers are applied.

15. The method of claim 10, wherein the non-metallic woven fabric substrate comprises fiberglass, carbon fiber, cellulose, nylon, polyamide-imide, polyimide, or a combination thereof.

16. The method of claim 10, wherein the resin comprises an epoxy, phenol-formaldehyde, urea-formaldehyde, melamine-formaldehyde, polyester-imide, polyimide, or a combination thereof.

17. The method of claim 16, wherein the resin further includes a filler comprising metal oxide, aluminum oxide, zirconia, silica dioxide, titanium dioxide, manganese black ferrite spinel, metal carbides, zirconia carbide, tungsten carbide, cementite, nano-ceramic, or a combination thereof.

18. The method of claim 16, wherein the resin further includes a toughening agent comprising carboxylate acrylonitrile butadiene rubber, polysulfone, polyether sulfone, polyester, polyphenylene ether, or a combination thereof.

19. The method of claim 10, wherein the one or more elastomeric layers comprise acrylonitrile butadiene rubber (NBR), hydronated butadiene rubber (HNBR), fluorinated rubber (FKM), acrylic rubber (ACM and AEM), ethylene propylene diene (EPDM), silicone (VMQ or PVMQ), fluorinated silicone (FVMQ), polyurethane (PU or PUR), or a combination thereof.

20. The method of claim 10, further comprising:
vulcanizing the one or more elastomeric layers through forced air, E-beam, calendering, infrared curing, or ultraviolet curing.
